(19) United States
(12) Patent Application Publication
(10) Pub. No.: US 2011/0302484 A1
(43) Pub. Date: Dec. 8, 2011

(54) Electronic Forms Completion Method

(76) Inventors: Bilal A. Abdelaquil, Houston, TX (US); Gerald E. Brooks, Missouri City, TX (US)

(21) Appl. No.: 13/155,134

(22) Filed: Jun. 7, 2011

Related U.S. Application Data
(60) Provisional application No. 61/352,638, filed on Jun. 8, 2010.

(51) Int. Cl. G06F 17/21

(52) U.S. Cl. 715/224

(57) ABSTRACT

An electronic forms completion method and apparatus. In one embodiment of the method, first and second data stored on a memory device is read. The first data and the second data is mapped to first and second columns, respectively, of a first record in a database. After mapping the first data and second data to the first and second columns, respectively, of the first record, the first and second data is stored in the first and second columns, respectively, of the first record. The first and second columns of the first record is then mapped to respective fields of an instance of a first electronic form. After mapping the first and second columns of the first electronic record to respective fields of the instance of the first electronic form, the first and second data is read from the first and second columns, respectively, of the first record. A visual representation of the instance of the first electronic form is generated, which comprises a visual representation of the first and second data read from the first and second columns, respectively, of the first record.

This application claims the benefit, under 35 U.S.C. §119(e), of U.S. Provisional Application No. 61/352,638, filed Jun. 8, 2010, entitled “Electronic Forms Completion Method,” and naming Bilal A. Abdelaquil and Gerald E. Brooks as inventors. The above-referenced application is hereby incorporated by reference herein in its entirety.

### BACKGROUND OF THE INVENTION

In the insurance and investment industries, as well as in other industries, agents, employees, or clients are required to fill out very lengthy electronic forms on behalf of themselves or their clients (hereinafter applicant). This process involves manually entering data into fields of electronic forms that are displayed by computer devices. Each displayed form may require entry of: name, mailing address, driver license number, issuing state of driver license, issue date of driver license, expiration date of driver license, date of birth, and other information. Once these electronic forms are completed, they are submitted to, for example, an insurance carrier for further processing. Unfortunately, it is not uncommon for forms to be rejected for failure to properly enter required information (e.g., date of birth).

### BRIEF DESCRIPTION OF THE DRAWINGS

The present invention may be better understood, and its numerous objects, features, and advantages made apparent to those skilled in the art by referencing the accompanying drawings.

FIG. 1 graphically illustrates relevant components of an example system that employs the present disclosure.

FIG. 2 graphically illustrates an example global data sheet table.

FIG. 3 is a flow chart that illustrates relevant aspects of a process implemented by the system in FIG. 1.

FIG. 4 graphically illustrates a visual representation of an example global data sheet record.

FIG. 5 is a flow chart that illustrates relevant aspects of a process implemented by the system in FIG. 1.

FIG. 6 is a block diagram of an example computing device or server that may be employed in the system of FIG. 1.

The use of the same reference symbols in different drawings indicates similar or identical items.

### DETAILED DESCRIPTION

Disclosed is a system and method for completing electronic forms. The method may include reading personal data from a memory device, such as a magnetic strip of a government issued drivers license, for subsequent storage in a database. Once stored in the database, the personal data can be used to generate distinct electronic forms such as applications for annuities or applications for life insurance. While the electronic forms may have visual representations which are distinct from each other, the forms are generated with little or no human intervention, thus reducing the likelihood that forms are rejected for failure to properly enter required information.

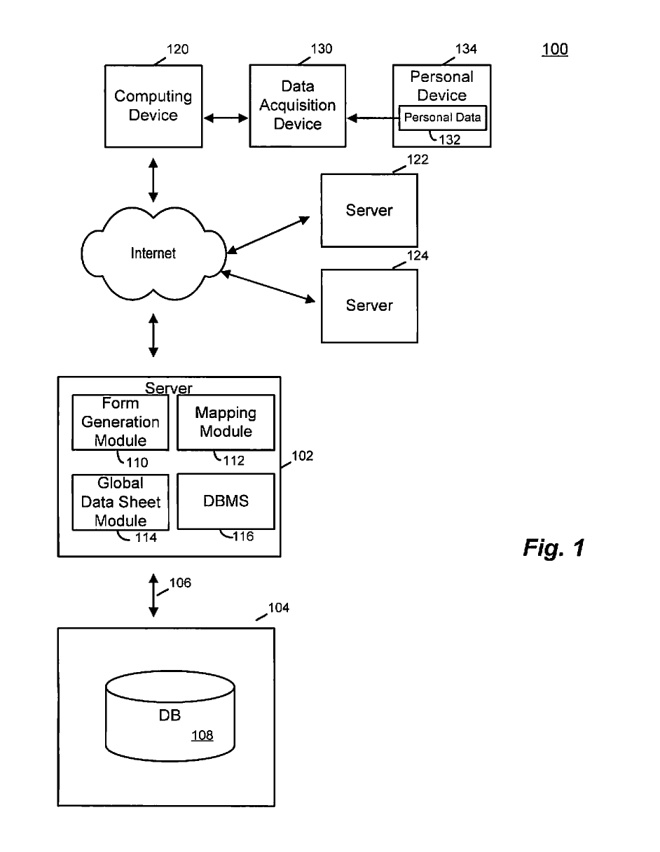

FIG. 1 illustrates in block diagram form relevant components of a system 100 employing one embodiment of the present invention, it being understood that the invention should not be limited to that shown in FIG. 1 or described therewith. Indeed, the present invention may employed in many different types of systems.

System 100 includes a server computer system (server) 102 in data communication with a data storage system 104 via a communication link 106. In one embodiment, data storage system 104 may take form in one or more disk arrays (not shown). For purposes of explanation only, the present disclosure will be described with reference to data storage system 104 containing a single disk array, it being understood that the present invention should not be limited thereto. Communication link 106 make take form in various components, such as routers, switches, bridges, etc., that enable data communication between server 102 and data storage system 104. The data communication include transactions to read or write data to data objects such as database tables, are stored in system 104.

The data storage system 104 is configured to present a database 108 to server 102 via communication link 106. Database 108 may take form in a relational database and may include several tables including a global data sheet table more fully described below. On a conceptual level a relational database generally includes a collection of tables, each of which may contain one or more records or rows. Each record may have one or more columns that contain data. Each record also includes a primary key that makes each record unique in a relational database. Primary keys alleviate the possibility of a duplicate record in a table.

Server 102 includes several components including a form generation module 110, a mapping module 112, a global data sheet module 114, and a database management system (DBMS) 116. In one embodiment, each of components 110-116 may take form in software instructions executing on one or more processors of server 102. The software instructions may be stored in one or more conventional computer readable mediums that may include, for example: magnetic storage media such as a magnetic disk (e.g., a disk drive); optical storage media such as an optical disk; solid state electronic storage devices such as random access memory (RAM), or read-only memory (ROM); or any other device or medium employed to store computer executable software instructions. Those skilled in the art will readily recognize that components 110-116 may be constructed in hardware or a combination of hardware and software.

In general, form generation module 110 is configured to create any one of several different electronic forms that can be subsequently displayed on a monitor of a computing device such as a desktop computer or a smart phone, printed, and/or transmitted to external servers for subsequent processing. These electronic forms can be generated using data from the global data sheet table that is mapped to fields of forms by mapping module 112. Global data sheet module 114 is configured to create new or update existing records within global data sheet table using data received from a computing device. Components 110-116 will be more fully described in the below paragraph.

Server 102 is in data communication with computing device 120, server 122, and server 124 via a wide area network (WAN) or a local area network (LAN). For purposes of explanation only, server 102 will be described as in communication with computing device 120 and servers 122 and 124 via a WAN such as the Internet. Computing device 120 can communicate with server 120 using a browser or other technology. In one embodiment a user of computing device 120 can create new electronic forms, update existing electronic forms, or forward completed electronic forms to server 122 or 124.

Servers 122 and 124 may include electronic forms processing modules (not shown), which may process electronic forms received from users of computing device 120 via server 102. Normally, server 122 or 124 employs software that processes the electronic forms for compliance with predetermined business rules. The fields of the electronic form can be compared to a required fields list to identify, for example, any deviations between information that is required and that which is or isn't provided in the electronic form. Any deviations can be highlighted or brought to the attention of the user who submitted the electronic form. In one embodiment, one or more deviations result in a blocking of a web-to-fax transmission of the electronic form to the vendor. Once corrections to the highlighted deviations are made, the system may submit the corrected electronic form, for example, in a web-to-fax transmission.

Computing device 120 may take form in any one of many different devices including a desktop computer, a laptop computer, a tablet (e.g. an iPad manufactured by Apple Computer, Inc.), a smart phone, or any other device that has one of our processors capable of executing software instructions stored in memory. Computing device 120 is in data communication with data acquisition device 130, which in turn is configured to read the contents of memory device 132 of portable device 134. Memory device 132 may take one of many different forms such as a magnetic strip, ROM, RAM, optical code, RFID chip, etc. For purposes of explanation only, portable device 134 is presumed to be a personal ID card such as a driver's license, and memory device 132 is presumed to be a magnetic strip, it being understood that the present disclosure should not be limited thereto. In one embodiment, magnetic strip 132 stores personal data that may include a name, a home address, a date of birth, a driver's license number, etc. Additionally, magnetic strip 132 may also store metadata that describes the personal data in addition to describing the format in which the personal data is stored. The content and format within magnetic strip 132 may vary in driver licenses issued by differing states.

Data acquisition device 130 reads personal data and metadata from magnetic strip 132. Data acquisition device 130 may take one of many different forms. In the example embodiment, data acquisition device 130 must be configured to read data and metadata of magnetic strip 132. The data is subsequently provided to computing device 120 where it is parsed according to one of several templates to create a list of personal data. Computing device 120 can transmit the parsed list of personal data to global data sheet module 114 of server 102 via the Internet in response to user command. In addition to transmitting the parsed list of personal data, the computing device 120 can transmit a request to create a new record or update an existing record within the aforementioned global data sheet table of database 108. The new or existing record should correspond to a person named in the parsed list of personal data.

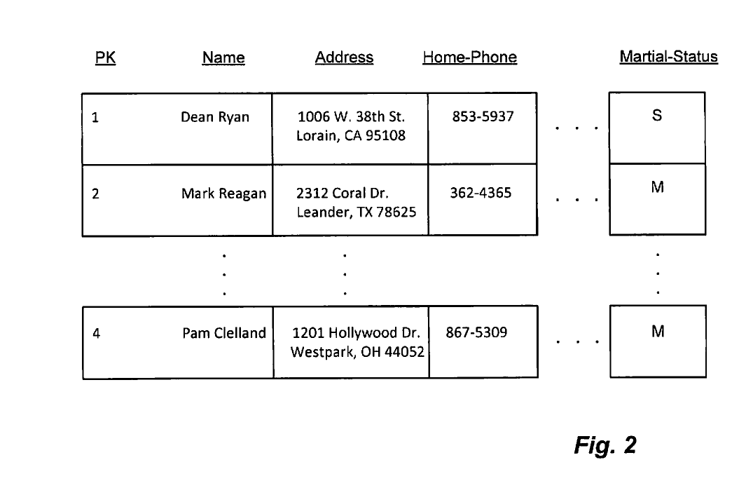

FIG. 2 illustrates a graphical representation of an example data sheet table contained within database 108 into which a new global data sheet record may be created or in which an existing global sheet data record may be updated by global data sheet module 114 via DBMS 116. In one embodiment, global data sheet module 114 may generate one or more SQL commands in response to receiving a transaction from computing device 120, such as a request to create or update an existing global data sheet record. These SQL commands in turn can be implemented by the DBMS 116 against database 108.

There are multiple SQL commands that can be generated by global data sheet module 114, which when implemented, update existing records within database tables, create new records, delete records, perform data base queries, etc. There are three basic data manipulation SQL commands: insert, update, and delete. The insert command is used to insert a new record into an existing table. Preexisting data within a record can be modified using the update command. The delete command can be used to remove entire records from a table. DBMS 116 is also capable of implementing SQL commands received, for example, from mapping module 112. These commands may include SQL commands to extract data for subsequent processing by the form generation module 110, which can generate electronic forms for a subsequent display on computing device 120, or for subsequent transmission to and processing by server 122 or 124.

FIG. 2, as noted above, illustrates an example global data sheet table contained at the data base 108. The table as shown contains multiple records each one of which contains a column into which data can be inserted or updated. For example, each record has a name column that stores a name. Additional information about the person identified in the name column, can be found in subsequent columns that include address, home_phone, marital_status, etc.

Parsed personal data received from the client computing device 120 can be stored within a global data sheet table record in respective columns thereof. Additional columns within records of the data sheet table shown in FIG. 2 can be populated with additional data. For example, hand written signatures of people can be scanned into digital data and then subsequently stored within records. Additional data may be stored in records via manual user entry into fields of a graphical user interface displayed by computing device 120 or another computing device. Ultimately, most records within the table shown in FIG. 2 contain personal data regarding respective individuals as acquired from magnetic strip 132 via data acquisition device 130 and computing device 120. As will be more fully described below, data within a record of the table shown in FIG. 2 can be used to generate distinct electronic forms via the mapping module 112 and form generation module 110.

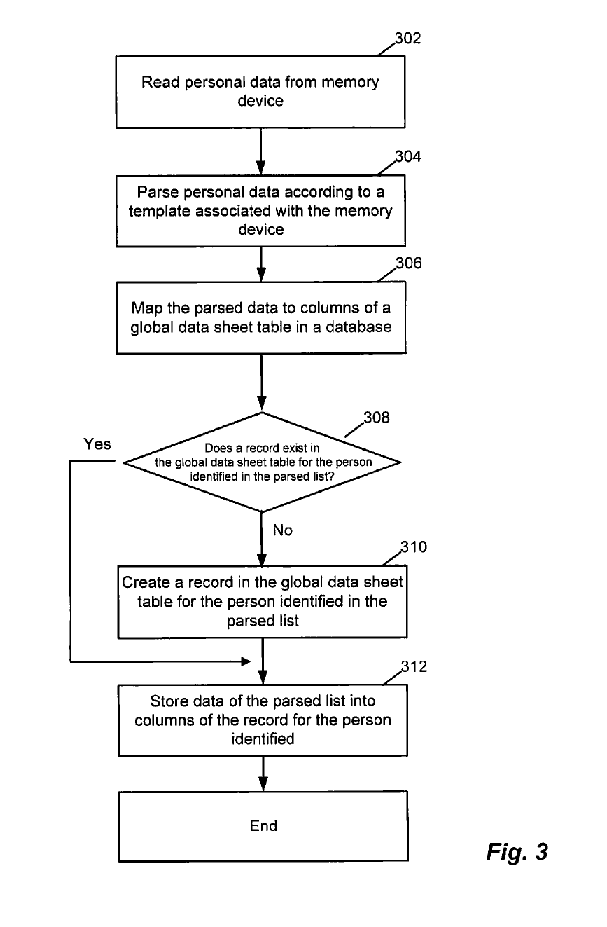

FIG. 3 illustrates relevant aspects of a process for creating a global data sheet record in accordance with one embodiment of the present invention. The process shown in FIG. 3 begins when a user of computing device 120 and data acquisition device 130 initiates a process to read personal data from magnetic strip 132. Computing device 120 subsequently parses the data read from magnetic strip 132 according to a template stored in memory (not shown). Computing device 120 may store several templates, each one of which may correspond to a respective format in which personal data is stored in a magnetic strip. In another embodiment, data parsing may be performed by the server 102 after the server 102 receives the personal data via computer device 120. Parsing the data creates list of personal data into components such as name, home address, date of birth, driver's license number, an identity of the state that issued the driver's license, etc. Regardless of whether the parsing is performed by computing device 120 or server 102, the global data sheet module 114 maps the parsed data of the list to columns of a global data sheet table in data base 108. It is noted that different magnetic strip 132 may provide distinct sets or lists of parsed data. For example, some magnetic strips may or may not contain a date of birth.

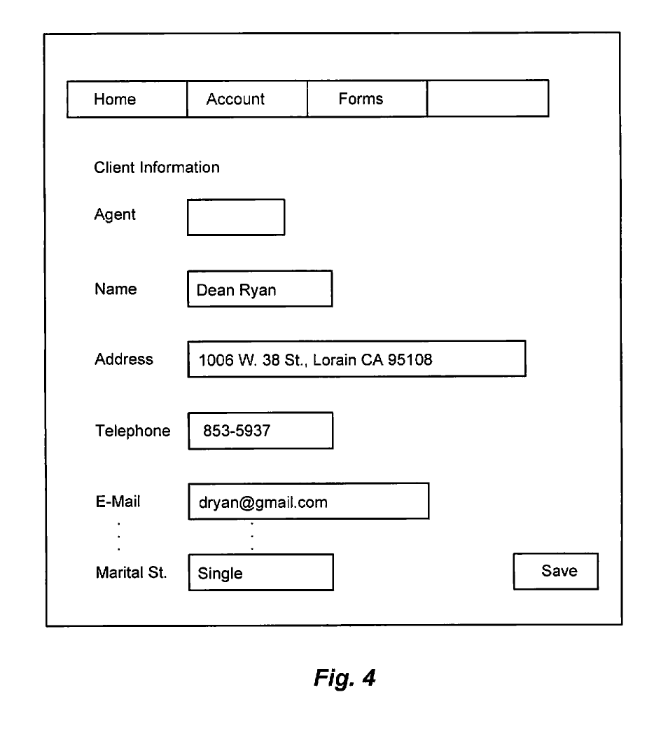

In step 308, the global data sheet module 114 determines whether a record exists within the global data sheet table for the person identified in the parsed list. This determination can be made via a SQL command implemented by DBMS 116. If no record exists for the person identified in the parsed list, global data sheet module 114 creates a new record in the global data sheet table for the person identified in the parsed list as shown in step 310. To create a new record, global data sheet 114 may generate a sequence of SQL commands that are implemented by DBMS 116. If, however, a record does exist within the global data sheet table for the person identified in the parsed list, then global data sheet module 114 stores data of the parsed list into the columns of the record for the person identified. Once the record is created or updated within the global data sheet table, one or more distinct electronic forms can be created by the server 102 in general, and form generation module 110 in particular, as will be more fully described below. Once a global data sheet record is created or updated, global data sheet module 114 can port that record to a customer relationship management (CRM) system, which can then electronically transmit auto generated marketing messages to various devices. Data of a global data sheet record can also be transmitted to computing device 120 where it can be displayed in a graphical user interface. More particular, a user of computing device 120 can initiate the display of data contained within a global data sheet record by activating a link from a list of links, each one of which corresponds to a respective person. FIG. 4 illustrates an example interface displayed on computing device 120 that corresponds to a record within the global data sheet table. This interface contains fields that correspond to respective fields of the record. A user of computing device 120 can update data within any of the fields. Although not shown within FIG. 4, a user of computing device 120 can save updates to the interface shown in FIG. 4 by clicking a save button.

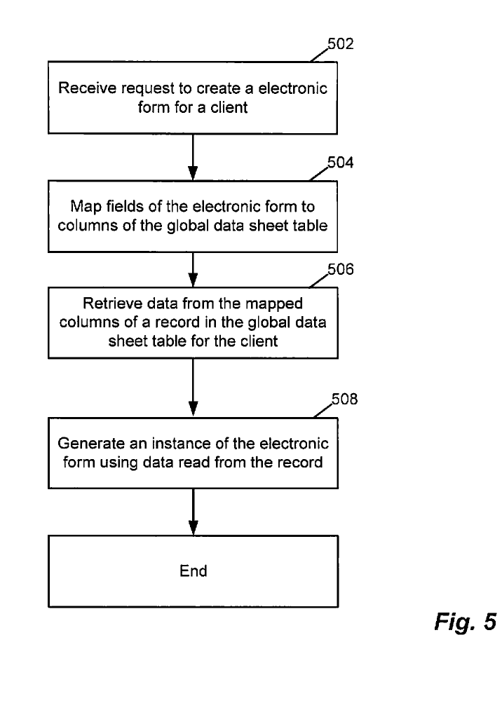

The interface provided in FIG. 4 may also enable a user to create one of many different electronic forms using data of the displayed global data sheet record. In one embodiment, a drop down menu can be displayed by the interface shown in FIG. 4, which allows a user of computing device 120 to select one of many different electronic forms. When the user selects an electronic form, computing device 120 sends a form generation command to server 102. FIG. 5 illustrates relevant aspects implemented by the server 102 in response to a user of computing device 120 initiating an action to generate an electronic form.

The process shown in FIG. 5 starts in step 502 when the form generation module 110 receives a request from computing device 120 to generate a new electronic form (e.g., an application for an annuity). The request may identify the electronic form and a name of a person (e.g., the annuity application applicant) for whom electronic form is to be generated. Form generation module 110, mapping module 112, or another module executing on server 102, may select and read a data object from memory (not shown) that corresponds to the requested electronic form. Multiple data objects corresponding to respective electronic forms are stored in memory accessible by server 102, and the data objects may identify fields of respective electronic forms into which data, including personal data stored in the global data sheet table, is to be entered. The data objects may also include additional information, which is provided to the form generation module and needed for generating the electronics form such as form format, text, etc.

Mapping module 112 may also receive the selected data object or the identity of fields contained therein. Mapping module 112 may also receive the name of the person (applicant) for which the electronic form is to be generated. The name can be used to access a record of the global data sheet table from which relevant data for the fields of the electronic form can be retrieved. The mapping module 112 can then map the identified fields of the selected electronic form to respective columns of the global data sheet record for the person. Global data sheet module 114 uses the mapping information to generate the SQL commands that are needed to retrieve data from the corresponding record. DBMS 116 implements the SQL commands and retrieves data from the mapped columns of the global data sheet table record for the person identified as shown in step 504. The global data sheet data, and form field identities mapped thereto, are subsequently forwarded to form generation module 110, which in turn populates fields of the electronic form. Thereafter, form generation module 110 generates the electronic form requested by computing device 120. Once this form is generated, it can be stored within memory (not shown) and/or subsequently transmitted to servers 122 or 124 in accordance with an instruction from a user of computing device 120. The electronic form can also be transmitted to computing device 120 for display on a monitor thereof. The visual representation of the form generated by module 110 can be edited by the user of computing device, for example, by modifying data within a graphical user interface that displays a visual representation of the electronic form.

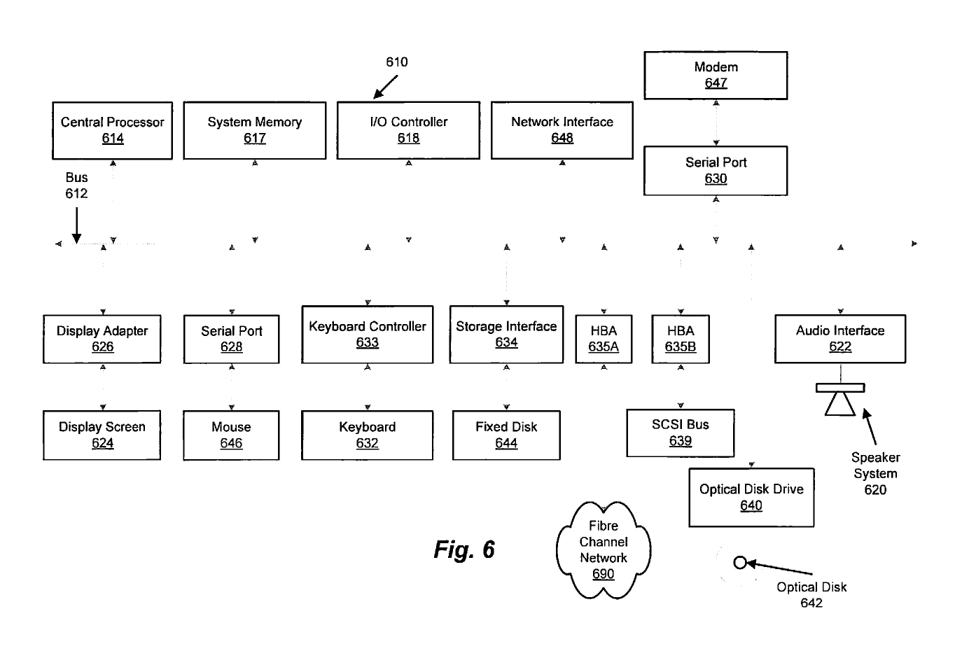

FIG. 6 depicts a block diagram of an example computer system 610 suitable for implementing part or all of the present disclosure. Computer system 610 includes a bus 612 which interconnects major subsystems of computer system 610, such as a central processor 614, a system memory 617 (typically RAM, but which may also include ROM, flash RAM, or the like), an input/output controller 618, an external audio device, such as a speaker system 620 via an audio output interface 622, an external device, such as a display screen 624 via display adapter 626, serial ports 628 and 630, a keyboard 632 (interfaced with a keyboard controller 633), a storage interface 634, a host bus adapter (HBA) interface card 635A operative to connect with a Fibre Channel network 690, a host bus adapter (HBA) interface card 635B operative to connect to a SCSI bus 639, and an optical disk drive 640 operative to receive an optical disk 642. Also included are a mouse 646 (or other point-and-click device, coupled to bus 612 via serial port 628), a modem 647 (coupled to bus 612 via serial port 630), and a network interface 648 (coupled directly to bus 612).

Bus 612 allows data communication between central processor 614 and system memory 617, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Software instructions resident with computer system 610 are generally stored on and accessed via a computer readable medium, such as a hard disk drive (e.g., fixed disk 644), an optical drive (e.g., optical drive 640), or other storage medium.

Storage interface 634, as with the other storage interfaces of computer system 610, can connect to a standard computer readable medium for storage and/or retrieval of information, such as a fixed disk drive 644. Fixed disk drive 644 may be a part of computer system 610 or may be separate and accessed through other interface systems. Modem 647 may provide a direct connection to a remote server via a telephone link or to the Internet via an internet service provider (ISP). Network interface 648 may provide a direct connection to a remote server via a direct network link to the Internet via a POP (point of presence). Network interface 648 may provide such connection using wireless techniques, including digital cellular telephone connection, Cellular Digital Packet Data (CDPD) connection, digital satellite data connection or the like.

Many other devices or subsystems (e.g., data acquisition device 130) may be connected in a similar manner. Conversely, all of the devices shown in FIG. 6 need not be present to practice the present disclosure. The devices and subsystems can be interconnected in different ways from that shown in FIG. 6. The operation of a computer system such as that shown in FIG. 6 is readily known in the art and is not discussed in detail in this application. Code to implement the present disclosure can be stored in computer-readable storage media such as one or more of system memory 617, fixed disk 644, etc. Memory 620 is also used for storing temporary variables or other intermediate information during the execution of instructions by the processor 610. The operating system provided on computer system 610 may be MS-DOSS, MS-WINDOWS®, OS/2®, UNIX®, Linux®, or another known operating system.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

We claim:

1. A method comprising:
reading first and second data stored on a memory device;
mapping the first data and the second data to first and second columns, respectively, of a first record in a database;
after mapping the first data and second data to the first and second columns, respectively, of the first record, storing the first and second data in the first and second columns, respectively, of the first record;
mapping the first and second columns of the first record to respective fields of an instance of a first electronic form;
after mapping the first and second columns of the first electronic record to respective fields of the instance of the first electronic form, reading the first and second data from the first and second columns, respectively, of the first record;
generating a visual representation of the instance of the first electronic form, which comprises a visual representation of the first and second data read from the first and second columns, respectively, of the first record.

2. The method of claim 1 further comprising:
mapping the first and second columns of the first record to respective fields of an instance of a second electronic form;
after mapping the first and second columns of the first record to respective fields of the instance of the second electronic form, reading the first and second data from the first and second columns, respectively, of the first record;
generating a visual representation of the instance of the second electronic form, which comprises a visual representation of the first and second data read from the first and second columns, respectively, of the first record;
wherein the visual representation of the instance of the first electronic form comprises text that is not contained in the visual representation of the instance of the second electronic form.

3. The method of claim 2 wherein:
the mapping the first and second columns of the first record to first and second fields, respectively, of the instance of the first electronic form comprises accessing a first map that maps columns of the first record to respective fields of the instance of the first electronic form;
the mapping the first and second columns of the first record to the first and second fields, respectively, of the instance of the second electronic form comprises accessing a second map that maps columns of the first record to respective fields of the of the instance of second electronic form.

4. The method of claim 2 further comprising:
transmitting the instance of first electronic form to a first server via the Internet;
transmitting the instance of the second electronic form to a second server via the Internet.

5. The method of claim 1 wherein the memory device comprises a magnetic strip.

6. The method of claim 5 further comprising an act of parsing data read from the magnetic strip according to a first template that describes data stored on the magnetic strip.

7. The method of claim 6 further comprising:
reading data stored on a second magnetic strip;
parsing the data read from the second magnetic strip according to a second template that describes the data stored on the second magnetic strip, wherein the first and second templates are distinct, and wherein the first and second magnetic strips store different data in different formats;
mapping data read from the second magnetic strip to respective columns of a second record in the database;
after mapping the data read from the second magnetic strip to the respective columns of the second record, storing the data read from the second magnetic strip in the respective columns of the second record;
mapping columns of the second record to respective fields of another instance of the first electronic form;
after mapping columns of the second electronic record to respective fields of the other instance of first electronic form, reading data from columns, respectively, of the second record;
generating a visual representation of the other instance of the first electronic form, which comprises a visual representation of the data read from the second record.

8. An apparatus comprising:
a data acquisition device for reading first and second data stored on a memory device;
a computer system coupled to the data acquisition device, wherein the computer system comprises a computer readable medium of storing instructions that are executable by the computer system, wherein the computer system implements a method when the instructions are executed, the method comprising:
mapping the first data and the second data to first and second columns, respectively, of a first record in a database;
after mapping the first data and second data to the first and second columns, respectively, of the first record, storing the first and second data in the first and second columns, respectively, of the first record;
mapping the first and second columns of the first record to respective fields of an instance of a first electronic form;
after mapping the first and second columns of the first electronic record to respective fields of the instance of the first electronic form, reading the first and second data from the first and second columns, respectively, of the first record;
transmitting data of a visual representation of the instance of the first electronic form, which comprises a visual representation of the first and second data read from the first and second columns, respectively, of the first record.

9. The apparatus of claim 8 wherein the method further comprises:
mapping the first and second columns of the first record to respective fields of an instance of a second electronic form;
after mapping the first and second columns of the first record to respective fields of the instance of the second electronic form, reading the first and second data from the first and second columns, respectively, of the first record;
transmitting data of a visual representation of the instance of the second electronic form, which comprises a visual representation of the first and second data read from the first and second columns, respectively, of the first record;
wherein the visual representation of the instance of the first electronic form, when displayed, comprises text that is not contained in the visual representation of the instance of the second electronic form, when displayed.

10. The apparatus of claim 9 wherein:
the mapping the first and second columns of the first record to first and second fields, respectively, of the instance of the first electronic form comprises accessing a first map that maps columns of the first record to respective fields of the instance of the first electronic form;
the mapping the first and second columns of the first record to the first and second fields, respectively, of the instance of the second electronic form comprises accessing a second map that maps columns of the first record to respective fields of the of the instance of second electronic form.

11. The apparatus of claim 9 wherein the method further comprises:
transmitting the instance of first electronic form to a first server via the Internet;
transmitting the instance of the second electronic form to a second server via the Internet.

12. The apparatus of claim 8 wherein the memory device comprises a magnetic strip.

13. The apparatus of claim 12 wherein the method further comprises an act of parsing data read from the magnetic strip according to a first template that describes data stored on the magnetic strip.

14. The apparatus of claim 13 wherein the method further comprises:
parsing data read from a second magnetic strip according to a second template that describes the data stored on the second magnetic strip, wherein the first and second templates are distinct, and wherein the first and second magnetic strips store different data in different formats;
mapping data read from the second magnetic strip to respective columns of a second record in the database;
after mapping the data read from the second magnetic strip to the respective columns of the second record, storing the data read from the second magnetic strip in the respective columns of the second record;
mapping columns of the second record to respective fields of another instance of the first electronic form;
after mapping columns of the second electronic record to respective fields of the other instance of first electronic form, reading data from columns, respectively, of the second record;
transmitting data of a visual representation of the other instance of the first electronic form, which comprises a visual representation of the data read from the second record.

15. A computer readable memory (CRM) comprising instructions, wherein a computer implements a method in response to executing the instructions, the method comprising:
mapping the first data and the second data read from a memory device to first and second columns, respectively, of a first record in a database;
after mapping the first data and second data to the first and second columns, respectively, of the first record, storing the first and second data in the first and second columns, respectively, of the first record;
mapping the first and second columns of the first record to respective fields of an instance of a first electronic form;
after mapping the first and second columns of the first electronic record to respective fields of the instance of the first electronic form, reading the first and second data from the first and second columns, respectively, of the first record;
transmitting data of a visual representation of the instance of the first electronic form, which comprises a visual representation of the first and second data read from the first and second columns, respectively, of the first record.

16. The CRM of claim 15 wherein the method further comprises:
mapping the first and second columns of the first record to respective fields of an instance of a second electronic form;
after mapping the first and second columns of the first record to respective fields of the instance of the second electronic form, reading the first and second data from the first and second columns, respectively, of the first record;
transmitting data of a visual representation of the instance of the second electronic form, which comprises a visual representation of the first and second data read from the first and second columns, respectively, of the first record;
wherein the visual representation of the instance of the first electronic form, when displayed, comprises text that is not contained in the visual representation of the instance of the second electronic form, when displayed.

17. The CRM of claim 16 wherein the method further comprises an act of parsing data read from the memory according to a first template that describes data stored on the magnetic strip.

18. The CRM of claim 17 wherein the method further comprises:
parsing the data read from a second memory device according to a second template that describes the data stored on the second magnetic strip, wherein the first and second templates are distinct, and wherein the first and second memory devices store different data in different formats;
mapping data read from the second memory device to respective columns of a second record in the database;
after mapping the data read from the second memory device to the respective columns of the second record, storing the data read from the second memory device in the respective columns of the second record;
mapping columns of the second record to respective fields of another instance of the first electronic form;
after mapping columns of the second electronic record to respective fields of the other instance of first electronic form, reading data from columns, respectively, of the second record;
transmitting data of a visual representation of the other instance of the first electronic form, which comprises a visual representation of the data read from the second record.
